(19) United States
(12) Patent Application Publication
(10) Pub. No.: US 2010/0246834 A1
(43) Pub. Date: Sep. 30, 2010

(54) WIND RECOGNITION SYSTEM AND METHOD FOR WIND RECOGNITION USING MICROPHONE

(75) Inventor: Sang Won LEE, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/647,087

(22) Filed: Dec. 24, 2009

(30) Foreign Application Priority Data
Mar. 24, 2009 (KR) 10-2009-0024854

(51) Int. Cl. H04R 29/00; H04R 3/00

(52) U.S. Cl. 381/56; 381/122

(57) ABSTRACT

A wind recognition system includes a sampling unit to sample data inputted through a microphone, an amplitude analysis unit to analyze an amplitude pattern of the sampled data, and a wind recognition unit to recognize the inputted data as wind if the analyzed amplitude pattern corresponds to a wind pattern. The amplitude analysis unit obtains amplitude data from the sampled data, and determines that the analyzed amplitude pattern corresponds to the wind pattern if the amplitude data includes n amplitudes each having a predetermined size. Alternatively, the amplitude analysis unit determines that the analyzed amplitude pattern corresponds to the wind pattern if a standard deviation of amplitudes included in the amplitude data is less than a reference deviation. Also, the wind recognition unit may recognize the inputted data as wind if the analyzed frequency spectrum of amplitude data corresponds to a wind prototype.

### CROSS-REFERENCE TO RELATED APPLICATION

This application claims priority from and the benefit of Korean Patent Application No. 10-2009-0024854, filed on Mar. 24, 2009, which is hereby incorporated by reference for all purposes as if fully set forth herein.

### BACKGROUND OF THE INVENTION

1. Field of the Invention

The present invention relates to a wind recognition system and a method for wind recognition using a microphone.

2. Discussion of the Background

Currently, a mobile terminal may provide a variety of functions such as a video call, a camera, a game, music and multimedia replay, satellite/terrestrial Digital Multimedia Broadcasting (DMB), as well as a voice call, Multimedia Message Service (MMS), and a Short Message Service (SMS).

Also, a wind recognition function may be provided. In a conventional art, however, a separate wind speed sensor for wind recognition is mounted in a mobile terminal, which may increase manufacturing costs.

FIG. 1 is a flowchart illustrating a method of operating a breath-sensitive toy in a conventional art.

As illustrated, a ‘breath-sensitive toy’ as described in PCT/US03/28600, published as WO/2004/024276, may be operated as follows: In operation S110, a breath sensor is operated. In operation S120, the toy determines whether a breath is sensed through humidity or temperature. In operation S130, a processor associated with breath information may be operated when human breath caused by speaking or blowing into the breath sensor is sensed. In operation S140, a feedback such as light or sound may be produced to trigger user's interest.

The breath-sensitive toy described above may use a breath sensor to recognize wind, and thereby may not achieve a light weight or reduction of manufacturing costs.

FIG. 2 is a flowchart illustrating a method for eliminating noise in a conventional art.

As illustrated, a ‘method and apparatus for eliminating the noise’ as described n Korean Patent Application No. 2002-0059106 is as follows: In operation S210, the method for eliminating the noise may receive a selection on a function such as a voice call. In operation S220, voice information may be received through a microphone while the selected function is performed. In operation S230, a frequency of the voice information may be analyzed, and is whether a frequency in an opposite phase occurs may be sensed. In operation S240, the voice information may be outputted through a speaker. In operation S250, it may be determined whether the function which is being performed may be canceled.

The method and apparatus for eliminating the noise described above may be used to extract desired voice information by eliminating a wind element corresponding to a noise from voice information, which may be opposite to a conventional art.

### SUMMARY OF THE INVENTION

Exemplary embodiments of the present invention provide a wind recognition method and system that may analyze an amplitude pattern of data inputted through a microphone, may determine amplitude data associated with the amplitude pattern corresponding to a wind pattern as a wind candidate group if the analyzed amplitude pattern corresponds to the wind pattern, may analyze a frequency spectrum of the amplitude data included in the wind candidate group, may recognize the inputted data as a wind if the analyzed frequency spectrum corresponds to a wind prototype, and thereby may determine whether the data inputted through the microphone is the wind without a separate sensor to sense a wind.

Exemplary embodiments of the present invention also provide a wind recognition method and system that may execute a wind-related application if data inputted through a microphone is recognized as a wind, and thereby may more efficiently execute an application in response to a wind input from a user.

Additional features of the invention will be set forth in the description which follows, and in part will be apparent from the description, or may be learned by practice of the invention.

An exemplary embodiment of the present invention discloses a wind recognition system, including a sampling unit to sample data inputted through a microphone; an amplitude analysis unit to analyze an amplitude pattern of the sampled data; and a wind recognition unit to recognize the inputted data as wind if the amplitude pattern corresponds to a wind pattern.

An exemplary embodiment of the present invention discloses a mobile terminal, including a microphone to receive data, a sampling unit to sample the data inputted to the microphone, an amplitude analysis unit to analyze an amplitude pattern of the sampled data, a wind recognition unit to recognize the inputted data as wind if the amplitude pattern corresponds to a wind pattern, and an application execution unit to execute an application associated with the recognized wind.

An exemplary embodiment of the present invention discloses a wind recognition method, including sampling data inputted through a microphone; analyzing an amplitude pattern of the sampled data; and recognizing the inputted data as wind if the amplitude pattern corresponds to a wind pattern.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method of operating a breath-sensitive toy according to the conventional art.

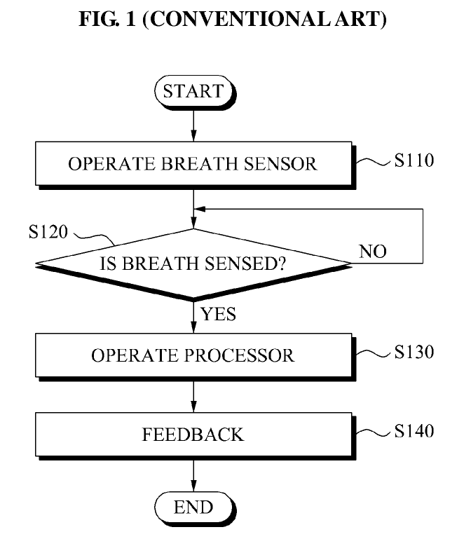

FIG. 2 is a flowchart illustrating a method of eliminating noise according to the conventional art.

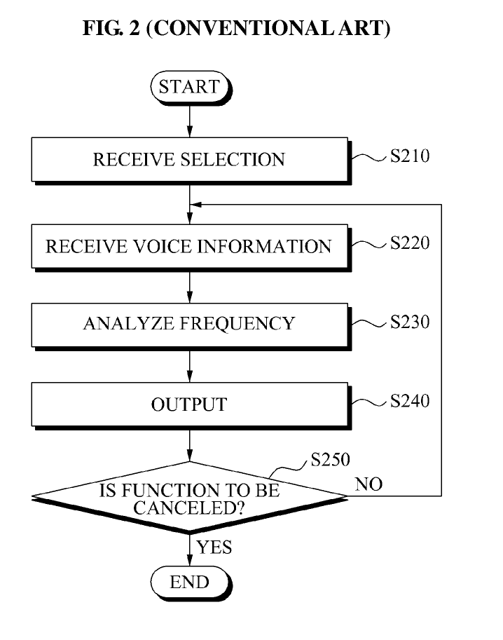

FIG. 3 is a block diagram illustrating a wind recognition system according to an exemplary embodiment of the present invention.

FIG. 4 is a diagram illustrating the analysis of an amplitude pattern in a wind recognition system according to an exemplary embodiment of the present invention.

FIG. 5 is a diagram illustrating the analysis of a frequency in a wind recognition system according to an exemplary embodiment of the present invention.

FIG. 6 is a diagram illustrating an amplitude pattern and a frequency of inputted data in a wind recognition system according to an exemplary embodiment of the present invention.

FIG. 7 is a flowchart illustrating a wind recognition method according to an exemplary embodiment of the present invention.

FIG. 8 is a block diagram illustrating a mobile terminal including a wind recognition system according to an exemplary embodiment of the present invention.

FIG. 9 is a diagram illustrating an execution of an application in a mobile terminal including a wind recognition system according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

A wind recognition system according to an exemplary embodiment of the present invention may be mounted in or outside of a mobile terminal. Hereinafter, an embodiment where the wind recognition system is mounted in the mobile terminal is described. However, the present invention is not limited as such.

The mobile terminal according to an exemplary embodiment of the present invention may include any one of various kinds of portable devices such as a notebook computer, a cellular phone, a Personal Communication Service (PCS) phone, a satellite/terrestrial Digital Multimedia Broadcasting (DMB) phone, a Personal Digital Assistant (PDA), a Portable Multimedia player (PMP), a Moving Picture Experts Group Audio-Layer 3 (MP3) player, and the like.

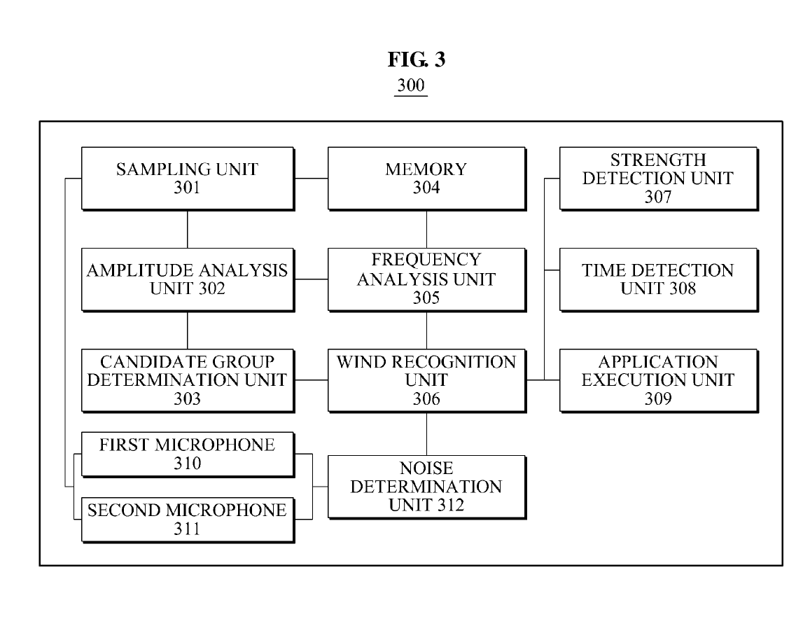

FIG. 3 is a block diagram illustrating a wind recognition system 300 according to an embodiment of the present invention.

As illustrated, the wind recognition system 300 may include a sampling unit 301, an amplitude analysis unit 302, and a wind recognition unit 306. The sampling unit 301 may sample data inputted through a microphone. The amplitude analysis unit 302 may analyze an amplitude pattern of the sampled data. The wind recognition unit 306 may recognize the inputted data as wind if the analyzed amplitude pattern corresponds to a wind pattern.

The data may include various information such as voice, noise, wind, and the like, inputted through the microphone. The sampling unit 301 may sample the data at regular intervals. The regular interval may be determined by a manager of the wind recognition system 300. For example, the sampling unit 301 may sample the data at optimum regular intervals to analyze a wind element of the data.

The amplitude analysis unit 302 may obtain amplitude data from the sampled data, and determine that the analyzed amplitude pattern corresponds to the wind pattern if the obtained amplitude data includes n amplitudes. Here, each of the n amplitudes may have a predetermined size, and n may be a natural number. Alternatively, the amplitude analysis unit 302 may determine that the analyzed amplitude pattern corresponds to the wind pattern if a standard deviation of amplitudes, included in the obtained amplitude data, is less than a reference deviation.

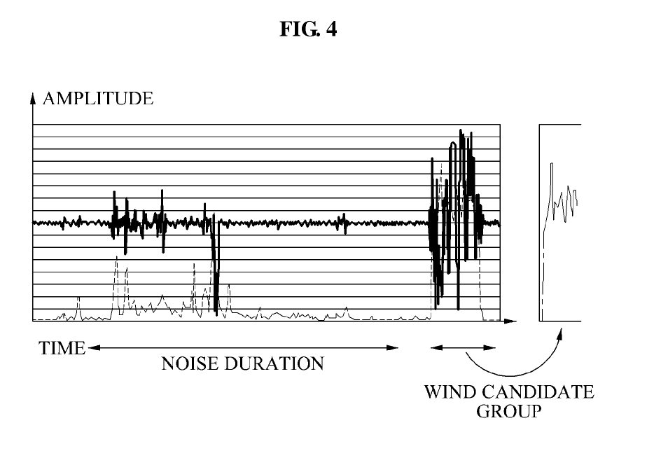

Hereinafter, an example of analyzing an amplitude pattern is described in detail with reference to FIG. 4.

FIG. 4 is a diagram illustrating the analysis of an amplitude pattern in the wind recognition system 300 according to an embodiment of the present invention.

As illustrated, the amplitude analysis unit 302 may input the sampled data in an amplitude pattern analyzer, and obtain amplitude data where a horizontal axis indicates ‘time’ and a vertical axis indicates ‘amplitude’. Here, the obtained amplitude data may be Pulse Code Modulation (PCM) data. The amplitude analysis unit 302 may analyze a portion having an irregular amplitude pattern in the obtained amplitude data as a noise duration, and may analyze a portion having a consecutive amplitude pattern as the wind pattern.

According to an exemplary embodiment of the present invention, the wind may have a consecutive amplitude pattern. Accordingly if at least n amplitudes are consecutively shown in the obtained amplitude data, since an amplitude pattern of the amplitude data is consecutive, the amplitude analysis unit 302 may determine that the analyzed amplitude pattern corresponds to the wind pattern. Each of the n amplitudes may have a predetermined size, and n may denote a natural number greater than one. Also, n may be set by the manager based on a characteristic of the wind pattern. For example if a size of the amplitude of the wind pattern is five, and an amplitude pattern having the amplitude size of five is repeated at least ten times, that is if the amplitude data includes ten amplitudes having the amplitude size of at least five, the amplitude analysis unit 302 may determine that the amplitude pattern corresponds to the wind pattern.

Also, according to an exemplary embodiment of the present invention, an amplitude of wind is generally linear, and a deviation of amplitudes is not significant. Accordingly if a standard deviation of amplitudes, included in the obtained amplitude data, is less than a reference deviation, the amplitude analysis unit 302 may determine that the amplitude pattern corresponds to the wind pattern, since the deviation of the amplitudes is insignificant. The standard deviation may indicate a distribution of the amplitudes included in the amplitude data. The amplitude analysis unit 302 may calculate the standard deviation of the amplitudes included in the obtained amplitude data using an equation that is generally used to calculate a standard deviation. The reference deviation may be set by the manager based on a deviation feature of amplitudes of the wind pattern. For example if the reference deviation is 0.2, the amplitude analysis unit 302 may determine that the amplitude pattern corresponds to the wind pattern if a standard deviation of the amplitudes included in the amplitude data is 0.1, which is less than the reference deviation of 0.2.

As described above, through the amplitude analysis of the inputted data, the wind recognition system 300 may reduce an error rate due to an external shock or a scratch. That is, the wind recognition system 300 may perform a frequency analysis with respect to only data having an amplitude pattern corresponding to the wind pattern from among the data inputted through the microphone.

The wind recognition system 300 may further include a candidate group determination unit 303 and a frequency analysis unit 305. The candidate group determination unit 303 may determine amplitude data, associated with the analyzed amplitude pattern corresponds to the wind pattern, as a wind candidate group. The frequency analysis unit 305 may analyze a frequency spectrum of the amplitude data included in the wind candidate group. In this instance, the wind recognition unit 306 may recognize the inputted data as the wind if the analyzed frequency spectrum corresponds to a wind prototype.

Referring to FIG. 4, the candidate group determination unit 303 may determine a portion having a continuous amplitude pattern as the wind candidate group.

According to an exemplary embodiment of the present invention, the frequency analysis unit 305 may perform a fast Fourier transform (FFT) with respect to the amplitude data included in the wind candidate group, and obtain the frequency spectrum as a result of the FFT. Also, the frequency analysis unit 305 may determine whether the obtained frequency spectrum corresponds to the wind prototype. That is, the frequency analysis unit 305 may adjust a sampling rate of FFT based on a performance of the mobile terminal where the wind recognition system 300 is embedded, and may perform the FFT with respect to the amplitude data based on the adjusted sampling rate. When the FFT is performed, the frequency analysis unit 305 may obtain a frequency spectrum where a horizontal axis indicates ‘frequency’ and a vertical axis indicates ‘amplitude’.

Other methods in addition to the FFT may be used as a transform method to interpret data of a time domain in a frequency domain. Accordingly, a method for the frequency analysis may not be limited to the FFT, and other frequency analysis methods may be used depending on the performance of the mobile terminal where the wind recognition system 300 is embedded.

In general, a short distance wind and a long distance wind may have different frequency spectrums. A short distance frequency spectrum and a long distance frequency spectrum with respect to wind may be obtained through an experiment. Here, a short distance frequency spectrum and a long distance frequency spectrum with respect to the wind may be referred to as a wind prototype. The wind recognition system 300 may further include a memory 304 that may store a wind prototype associated with a short distance or long distance

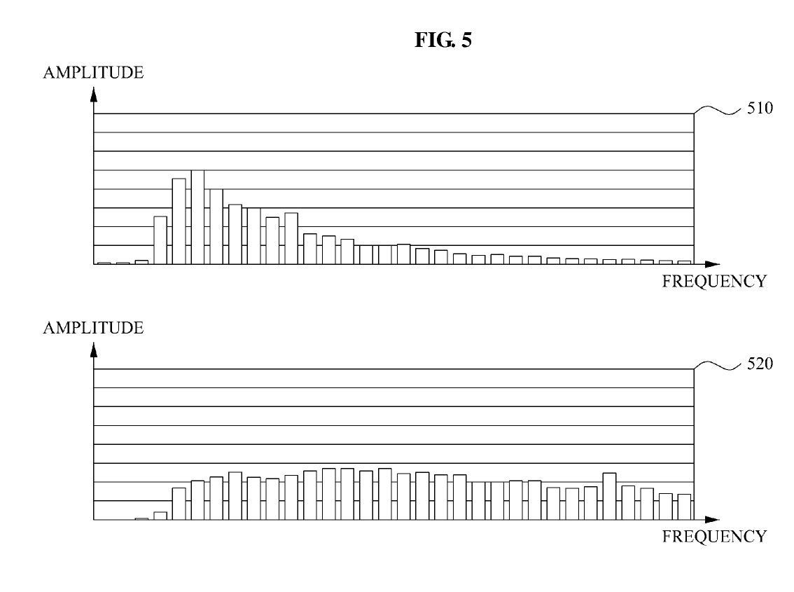

Hereinafter, an example of a frequency analysis is described in detail with reference to FIG. 5.

FIG. 5 is a diagram illustrating the analysis of a frequency in a wind recognition system according to an embodiment of the present invention.

As illustrated, a wind prototype illustrated in a graph 510 may denote a frequency spectrum associated with a long distance, and a wind prototype illustrated in a graph 520 may denote a frequency spectrum associated with a short distance. The wind prototype associated with the short distance or the long distance may be stored in the memory 304. The memory 304 may store at least two wind prototypes depending on a characteristic of the mobile terminal.

In this instance, the frequency analysis unit 305 may compare the obtained frequency spectrum with the stored wind prototype, and determine that the frequency spectrum corresponds to the wind prototype if a standard deviation of the frequency spectrum and the wind prototype is less than a reference error. The standard deviation of the frequency spectrum and the wind prototype may indicate a distribution of the frequency spectrum and the wind prototype. The reference error may be set by the administrator of the wind recognition system 300 based on a characteristic of a wind prototype. For example if the reference error is significant, a trade-off may occur due to an increase in an error rate of wind recognition, although a wind recognition rate may increase. Accordingly, the administrator may set the reference error based on the trade-off.

The error rate of wind recognition due to an element other than wind, despite having a similar frequency, may be reduced through the frequency analysis. In this instance, the data may include a human voice, a sound from a television (TV), music, and the like.

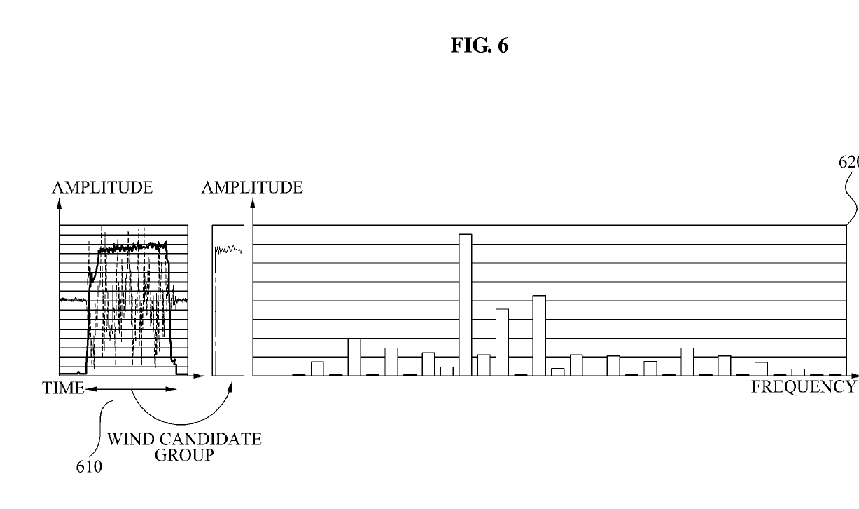

FIG. 6 is a diagram illustrating an amplitude pattern and a frequency of inputted data in a wind recognition system according to an embodiment of the present invention.

As shown in a graph 610, the amplitude analysis unit 302 may analyze the amplitude pattern of the data which is sampled by the sampling unit 301. The graph 610 may show amplitude data when data, inputted through the microphone, is a voiced sound similar to ‘Ahh’. The amplitude analysis unit 302 may analyze and determine that a portion showing a continuous amplitude pattern corresponds to a wind pattern, and may also determine the portion as a wind candidate group.

As illustrated in a graph 620, the frequency analysis unit 305 may analyze the frequency spectrum of the amplitude data included in the wind candidate group. For example, the frequency analysis unit 305 may compare the analyzed frequency spectrum with the stored wind prototype. The graph 620 may show a frequency spectrum when data, inputted through the microphone, is a voice sounding similar to ‘Ahh’. Accordingly, the frequency spectrum of the graph 620 may not be determined as a wind element by comparing the frequency spectrum of the graph 620 with the frequency spectrum illustrated in the graph 510 of FIG. 5.

As described above if the analyzed amplitude pattern corresponds to the wind pattern, the wind recognition system 300 may determine the amplitude data as the wind candidate group. However if the inputted data has frequency characteristics different from the wind prototype, the wind recognition system 300 may exclude the inputted data from the wind candidate group.

Referring back to FIG. 3, the wind recognition system 300 may further include a first microphone 310, a second microphone 311, and a noise determination unit 312. The amplitude analysis unit 302 may analyze a first amplitude rate and a second amplitude rate. The first amplitude rate may be associated with data inputted through the first microphone 310 and sampled, and the second amplitude rate may be associated with data inputted through the second microphone 311 and sampled. The noise determination unit 312 may determine that data, inputted through the first microphone 310 and the second microphone 311, is a noise if the first amplitude rate and the second amplitude rate are greater than a reference amplitude rate.

The wind recognition system 300 may include the first microphone 310 and the second microphone 311, and thereby may improve a noise elimination performance and wind recognition performance. The reference amplitude rate may be set based on a characteristic of noise.

Accordingly if the inputted data is recognized as the wind, the wind recognition system 300 may further include an application execution unit 309 to execute a wind-related application. The application may be any one of functions previously set by the manager in the mobile terminal. For example, the application may be a function performed by pushing a button such as making a call, answering a phone, sending a message, and the like.

The wind recognition system 300 may further include a strength detection unit 307 or a time detection unit 308. The strength detection unit 307 may detect a strength of the wind from the inputted data, and the time detection unit 308 may detect a wind blowing time from the inputted data. That is, the wind recognition system 300 may detect the strength or the wind blowing time of the wind as additional information of the inputted data. For example, the strength detection unit 307 may detect the strength of the wind using an amplitude size of the amplitude data, and the time detection unit 308 may detect the wind blowing time using a cycle of the amplitude data.

For example if wind is detected from inputted data while a text message is being written, and a strength of the detected wind is ‘weak’, the application execution unit 309 may display a single image such as a heart image. When the strength of the detected wind is ‘strong’, the application execution unit 309 may display multiple heart images or larger heart images.

Also, while an image of a lighted candle is displayed on an idle screen if a wind is detected and a wind blowing time of the detected wind is equal to or less than a first time, such as two seconds, the application execution unit 309 may change the lighted candle image into an image where the candle flame flickers. If the wind blowing time of the detected wind is equal to or greater than the first time or a second time, such as four seconds, the application execution unit 309 may change the lighted candle image into an image where a candle flame is extinguished.

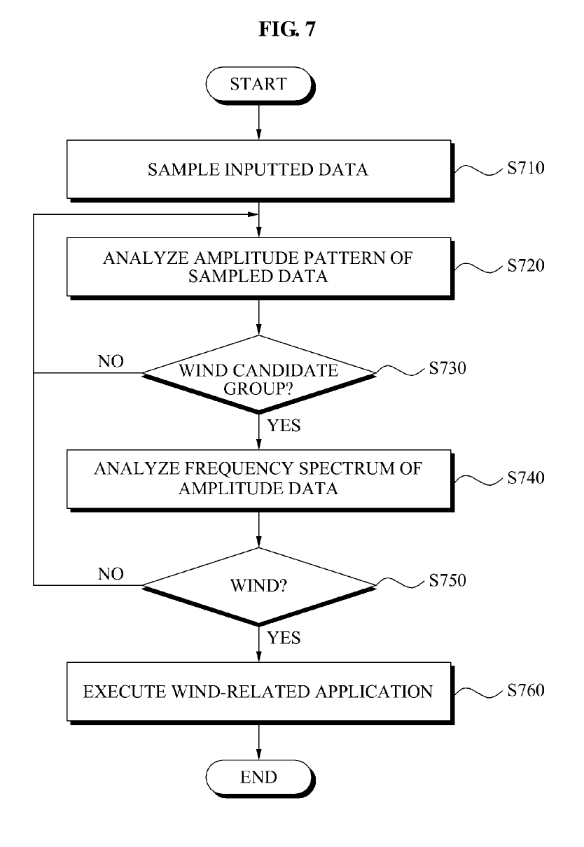

FIG. 7 is a flowchart illustrating a wind recognition method according to an exemplary embodiment of the present invention.

The wind recognition method may be performed by the wind recognition system 300, but is not limited thereto. Accordingly, the wind recognition method is described with reference to FIG. 3.

In operation S710, a sampling unit 301 may sample data inputted through a microphone. For example, the sampling unit 301 may sample the data at regular intervals to analyze a wind element of the inputted data.

In operation S720, an amplitude analysis unit 302 may analyze an amplitude pattern of the sampled data. The amplitude analysis unit 302 may obtain amplitude data from the sampled data, and may analyze whether the obtained amplitude data includes n amplitudes, or whether a standard deviation of amplitudes, included in the obtained amplitude data, is less than a reference deviation. Here, each of the n amplitudes may have a predetermined size, and n may be a natural number. If the obtained amplitude data includes the n amplitudes, or if the standard deviation of the amplitudes included in the obtained amplitude data is less than the reference deviation, the amplitude analysis unit 302 may determine that the amplitude pattern corresponds to a wind pattern.

In operation S730, if the amplitude pattern corresponds to the wind pattern, a candidate group determination unit 303 may determine the amplitude data as a wind candidate group, and proceed to operation S740. However if the amplitude pattern does not correspond to the wind pattern, the candidate group determination unit 303 may return to operation S720.

In operation S740, a frequency analysis unit 305 may analyze a frequency spectrum of the amplitude data included in the wind candidate group. For this, the frequency analysis unit 305 may perform an FFT with respect to the amplitude data included in the wind candidate group, and obtain the frequency spectrum as a result of the FFT. Also, the frequency is analysis unit 305 may determine whether the obtained frequency spectrum corresponds to a wind prototype. The wind prototype may be stored in a memory 304 of the wind recognition system 300.

In operation S750, if the frequency spectrum corresponds to the wind prototype, a wind recognition unit 306 may recognize the inputted data as wind, and may proceed to operation S760. However if the frequency spectrum does not correspond to the wind prototype, the wind recognition unit 306 may return to operation S720.

In operation S760, if the inputted data is recognized as wind, an application execution unit 309 of the wind recognition system 300 may execute a wind-related application. The application may be any one of functions previously set by a manager in a mobile terminal.

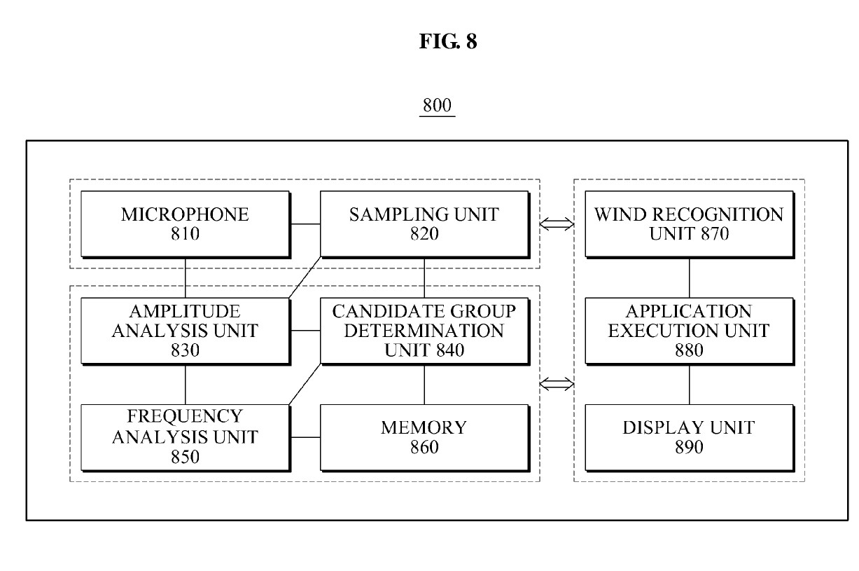

FIG. 8 is a block diagram illustrating a mobile terminal 800 including a wind recognition system according to an exemplary embodiment of the present invention.

As illustrated, the mobile terminal 800 may include a microphone 810, a sampling unit 820, an amplitude analysis unit 830, a wind recognition unit 870, and an application execution unit 880. The microphone 810 may receive data. The sampling unit 820 may sample the inputted data received at the microphone 810. The amplitude analysis unit 830 may analyze an amplitude pattern of the sampled data. The wind recognition unit 870 may recognize the inputted data as wind if the analyzed amplitude pattern corresponds to a wind pattern. The application execution unit 880 may execute an application associated with the recognized wind.

The microphone 810 may receive data including information such as voice, noise, wind, and the like. According to an exemplary embodiment of the present invention, the mobile terminal 800 may include at least one microphone 810 such as a main microphone (first microphone) and a sub-microphone (second microphone).

The sampling unit 820 may sample the inputted data at regular intervals. For example, the sampling unit 820 may sample the inputted data at regular intervals to analyze a wind element of the data.

The amplitude analysis unit 830 may obtain amplitude data from the sampled data, and determine that the amplitude pattern corresponds to a wind pattern if the obtained amplitude data includes n amplitudes, or if a standard deviation of amplitudes, included in the obtained amplitude data, is less than a reference deviation (by referring to the wind candidate group of FIG. 4). Here, each of the n amplitudes may have a predetermined size, and n may be a natural number.

The mobile terminal 800 may further include a candidate group determination unit 840, a frequency analysis unit 850, and a memory 860. The candidate group determination unit 840 may determine amplitude data, associated with the analyzed amplitude pattern, as a wind candidate group. The frequency analysis unit 850 may analyze a frequency spectrum of the amplitude data included in the wind candidate group. The memory 860 may store a wind prototype associated with short distance or long distance. In this instance, the frequency analysis unit 850 may compare the analyzed frequency spectrum with the wind prototype stored in the memory 860. Also if a standard deviation of the frequency spectrum and the wind prototype is less than a reference error, the frequency analysis unit 850 may determine that the frequency spectrum corresponds to the wind prototype (by referring to frequency spectrums of FIG. 5). Accordingly, the wind recognition unit 870 may recognize the inputted data as the wind if the analyzed frequency spectrum corresponds to the wind prototype.

The mobile terminal 800 may further include a display unit 890 to display an application, executed if the inputted data is recognized as wind, on a screen.

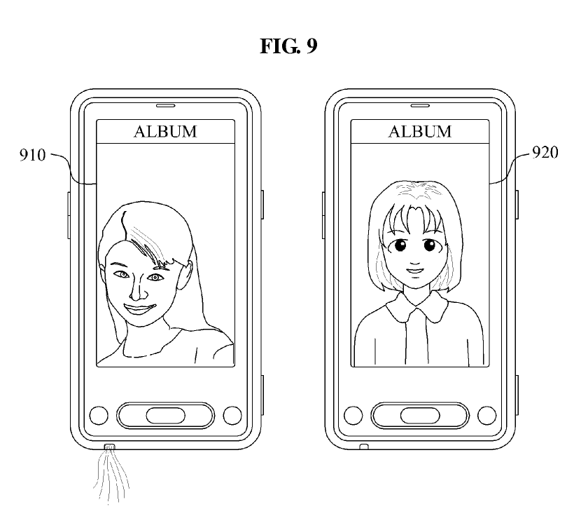

FIG. 9 is a diagram illustrating an execution of an application in a mobile terminal including a wind recognition system according to an embodiment of the present invention.

As illustrated in a screen 910, the display unit 890 may display a picture on the screen 910. When a user desires to move to another picture, the user may push a ‘next’ button or blow into the microphone 810. Here, it may be assumed that the user blows into the microphone 810. In this instance, the mobile terminal 800 may analyze whether an input is a wind using an amplitude analysis method and a frequency analysis method. If the input is recognized as the wind, the movement to the other picture may be performed.

Accordingly, the display unit 890 may display the other picture which is stored subsequent to the picture displayed on the screen 910, as illustrated in a screen 920.

Also, the application execution unit 880 may execute the wind-related application associated with the recognized wind, such as moving to a subsequent file, sending a message, making a call, and the like, through the display unit 890. That is, the mobile terminal 800 may execute a desired application by blowing into a microphone 810 as a method for inputting a command to the mobile terminal 800.

The above-described embodiments of the present invention may be recorded in computer-readable media including program instructions to execute various operations embodied by a computer. The media may also include, alone or in combination with the program instructions, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A wind recognition system, comprising:
a sampling unit to sample data inputted through a microphone;
an amplitude analysis unit to analyze an amplitude pattern of the sampled data; and
a wind recognition unit to recognize the inputted data as wind if the amplitude pattern corresponds to a wind pattern.

2. The wind recognition system of claim 1, wherein the amplitude analysis unit obtains amplitude data from the sampled data, and determines that the amplitude pattern corresponds to the wind pattern if the amplitude data includes n amplitudes, each of the n amplitudes having a predetermined size.

3. The wind recognition system of claim 1, wherein the amplitude analysis unit obtains amplitude data from the sampled data, and determines that the amplitude pattern corresponds to the wind pattern if a standard deviation of amplitudes included in the amplitude data is less than a reference deviation.

4. The wind recognition system of claim 1, further comprising:
a candidate group determination unit to determine amplitude data, associated with the amplitude pattern corresponding to the wind pattern, as a wind candidate group; and
a frequency analysis unit to analyze a frequency spectrum of the amplitude data included in the wind candidate group,
wherein the wind recognition unit recognizes the inputted data as the wind if the frequency spectrum corresponds to a wind prototype.

5. The wind recognition system of claim 4, wherein the frequency analysis unit performs a fast Fourier transform (FFT) with respect to the amplitude data included in the wind candidate group, obtains the frequency spectrum as a result of the FFT, and determines whether the frequency spectrum corresponds to the wind prototype.

6. The wind recognition system of claim 4, further comprising:
a memory to store a wind prototype associated with short distance or long distance,
wherein the frequency analysis unit compares the frequency spectrum with the stored wind prototype, and determines that the frequency spectrum corresponds to the wind prototype if a standard deviation of the frequency spectrum and the wind prototype is less than a reference error.

7. The wind recognition system of claim 1, further comprising:
a strength detection unit to detect a strength of the wind from the inputted data if the inputted data is recognized as wind.

8. The wind recognition system of claim 1, further comprising:
a time detection unit to detect a wind blowing time from the inputted data if the inputted data is recognized as wind.

9. The wind recognition system of claim 1, further comprising:
an application execution unit to execute a wind-related application if the inputted data is recognized as wind.

10. The wind recognition system of claim 1, wherein the microphone comprises a first microphone and a second microphone, and
the amplitude analysis unit analyzes a first amplitude rate associated with data inputted through the first microphone, and analyzes a second amplitude rate associated with data inputted through the second microphone, and the wind recognition system further comprises:
a noise determination unit to determine that data, inputted through the first microphone and the second microphone, is noise if the first amplitude rate and the second amplitude rate are greater than a reference amplitude rate.

11. A mobile terminal, comprising:
a microphone to receive data;
a sampling unit to sample the data inputted to the microphone;
an amplitude analysis unit to analyze an amplitude pattern of the sampled data;
a wind recognition unit to recognize the inputted data as wind if the amplitude pattern corresponds to a wind pattern; and
an application execution unit to execute an application associated with the recognized wind.

12. The mobile terminal of claim 11, further comprising:
a display unit to display the application.

13. The mobile terminal of claim 11, wherein the amplitude analysis unit obtains amplitude data from the sampled data, and determines that the amplitude pattern corresponds to the wind pattern if the amplitude data includes n amplitudes, or if a standard deviation of amplitudes included in the amplitude data is less than a reference deviation, each of the n amplitudes having a predetermined size.

14. The mobile terminal of claim 11, further comprising:
a candidate group determination unit to determine amplitude data, associated with the amplitude pattern corresponding to the wind pattern, as a wind candidate group; and
a frequency analysis unit to analyze a frequency spectrum of the amplitude data included in the wind candidate group,
wherein the wind recognition unit recognizes the inputted data as wind if the frequency spectrum corresponds to a wind prototype.

15. The mobile terminal of claim 14, further comprising:
a memory to store a wind prototype associated with short distance or long distance,
wherein the frequency analysis unit compares the frequency spectrum with the stored wind prototype, and determines that the frequency spectrum corresponds to the wind prototype if a standard deviation of the frequency spectrum and the wind prototype is less than a reference error.

16. A wind recognition method, comprising:
sampling data inputted through a microphone;
analyzing an amplitude pattern of the sampled data; and
recognizing the inputted data as wind if the amplitude pattern corresponds to a wind pattern.

17. The wind recognition method of claim 16, wherein analyzing the amplitude pattern comprises:
obtaining amplitude data from the sampled data; and
determining that the amplitude pattern corresponds to the wind pattern if the amplitude data includes n amplitudes, each of the n amplitudes having a predetermined size.

18. The wind recognition method of claim 16, wherein analyzing the amplitude pattern comprises:
obtaining amplitude data from the sampled data; and
determining that the amplitude pattern corresponds to the wind pattern if a standard deviation of amplitudes, included in the amplitude data, is less than a reference deviation.

19. The wind recognition method of claim 16, wherein recognizing the inputted data comprises:
determining amplitude data, associated with the amplitude pattern corresponding to the wind pattern, as a wind candidate group;
analyzing a frequency spectrum of the amplitude data included in the wind candidate group; and
recognizing the inputted data as wind if the frequency spectrum corresponds to a wind prototype.

20. The wind recognition method of claim 19, wherein analyzing the frequency spectrum comprises:
performing a fast Fourier transform (FFT) with respect to the amplitude data included in the wind candidate group;
obtaining the frequency spectrum of the amplitude data as a result of the FFT; and
determining whether the frequency spectrum corresponds to the wind prototype.

21. The wind recognition method of claim 19, wherein analyzing the frequency spectrum comprises:
storing a wind prototype associated with short distance or long distance in a memory;
comparing the frequency spectrum with the stored wind prototype; and
determining that the frequency spectrum corresponds to the wind prototype if a standard deviation of the frequency spectrum and the wind prototype is less than a reference error.

22. The wind recognition method of claim 16, further comprising:
detecting a strength of the wind from the inputted data if the inputted data is recognized as wind.

23. The wind recognition method of claim 16, further comprising:
executing a wind-related application if the inputted data is recognized as wind.

24. The wind recognition method of claim 16, further comprising:
detecting a wind blowing time from the inputted data if the inputted data is recognized as wind.
